(19) United States
(12) Patent Application Publication
(10) Pub. No.: US 2014/0135035 A1
(43) Pub. Date: May 15, 2014

(54) System for Item and Location Information Distribution

(71) Applicants: Kenneth A. Hirsch, Scottsdale, AZ (US); Briggs B. Cunningham, Chandler, AZ (US); Steven A. Lippert, Phoenix, AZ (US)

(72) Inventors: Kenneth A. Hirsch, Scottsdale, AZ (US); Briggs B. Cunningham, Chandler, AZ (US); Steven A. Lippert, Phoenix, AZ (US)

(73) Assignee: PRACTICAL INTELLECT, LLC, Chandler, AZ (US)

(21) Appl. No.: 13/673,736

(22) Filed: Nov. 9, 2012

(51) Int. Cl. H04W 4/02

(52) U.S. Cl. CPC H04W 4/025
USPC 455/456.3

(57) ABSTRACT

A system for item and location information distribution utilizes a mobile device, at least one wireless information node, and a data server. The information node actively broadcasts a node identification (NID) via a wireless communication signal. When a user brings the mobile device within range of the wireless communication signal, the signal is received by the mobile device, allowing it to receive the NID. The mobile device then requests data related to the node from either the data server or a locally stored database generated from data previously retrieved from the data server. Software on the mobile device may then display headings and subheadings on the screen of the mobile device. The user may select a particular heading or subheading to display the content of the associated chapter or subchapter on the screen of the mobile device.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to systems and methods of distributing information concerning items and locations.

2. Description of the Related Art

When a person seeks to gain additional information regarding a location or item, the person typically must seek out written descriptions in the form of signs, instructions, or other visual indicia. This method of information distribution can be problematic when the person is not immediately aware of the location of the indicia, line of sight to the indicia is obstructed, or vision of the person is otherwise impaired.

If a person is unable to quickly locate the indicia, the person may experience undesired delays in accessing location amenities or use of an item.

A solution is needed to address one or more of these shortcomings in the prior art.

### BRIEF SUMMARY OF THE INVENTION

The system for item and location information distribution of the present invention utilizes a mobile device, at least one wireless information node, and a data server.

The information node actively broadcasts a node identification (NID) via a wireless communication signal, such as a Bluetooth signal. When a user brings the mobile device within range of the wireless communication signal, the signal is received by the mobile device, allowing it to receive the NID. The mobile device may then request data related to the node from either the data server or a locally stored database generated from data previously retrieved from the data server.

The data may be presented in a file format suitable for compartmentalizing information, such as JavaScript Object Notation (JSON), Standard Generalized Markup Language (SGML), or Extensible Markup Language (XML). Software on the mobile device may then interpret the data as containing headings, subheadings, chapters, subchapters, or other organizational structures characterized by the data received.

Software on the mobile device may then display headings and subheadings on the screen of the mobile device. The user may select a particular heading or subheading to display the content of the associated chapter or subchapter on the screen of the mobile device.

A network of nodes may be used to provide an approximate location of the user. Signal strength of a wireless information node may be used to provide an approximate distance from that node. The addition of two or more additional nodes allows software on the mobile device to triangulate the approximate location of the mobile device, provided location coordinates of the nodes are known.

Once a user's approximate location is known, the mobile device may utilize map software to determine distance and direction to points of interest associated with data received by the mobile device.

Information displayed on the screen of the mobile device may be read by text-to-speech software on the mobile device, should the user wish to receive the information aurally, rather than visually.

### BRIEF DESCRIPTION OF THE SEVERAL VIEWS OF THE DRAWING

FIG. 1 depicts the system for item and location information distribution in use.

FIG. 2 depicts the system for item and location information distribution in use, determining the approximate location of a mobile device.

### DETAILED DESCRIPTION OF THE INVENTION

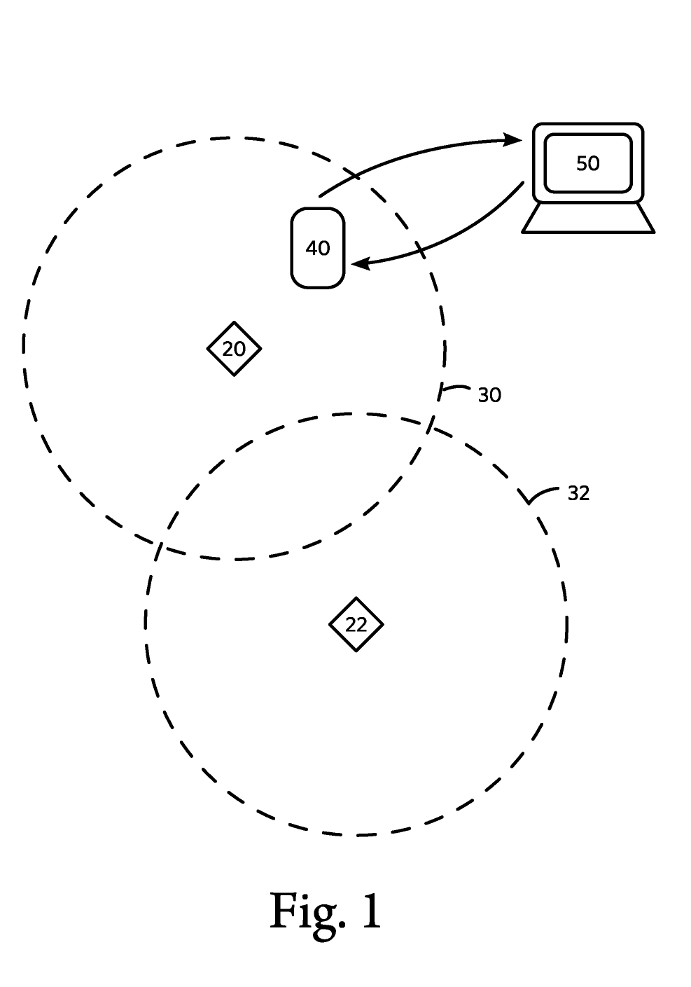

Referring now to FIG. 1, the system for item and location information distribution of the present invention utilizes a mobile device 40, at least one wireless information node 20, and a data server 50.

A mobile device 40, such as a mobile phone or tablet, is powered by a battery and contains a processor. The mobile device 40 may have internal memory or external memory which hold software code, such as an operating system, communication system software, and software settings.

The mobile device 40 further comprises a display and user interface, which may comprise a keypad, keyboard, touch screen, voice input, miscellaneous buttons, or trackball.

The mobile device 40 is further equipped with at least one data chip set suitable to establish a mobile data connection. The data chip set may allow a IEEE 802.11, EDGE, 3G, 4G, or other mobile data network connection. This mobile data connection enables the mobile device 40 to access other resources connected to the internet.

The mobile device 40 further comprises a local wireless communication chipset allowing connectivity to wireless communication, such as near field communication (NFC), radio-frequency identification (RFID), IEEE 802.11, or Bluetooth communication.

The information node 20 actively broadcasts a node identification (NID) via a wireless communication signal 30, such that the wireless communication signal 30 may be received by the mobile device 40. When a user brings the mobile device 40 within range of the wireless communication signal 30, the signal 30 is received by the mobile device 40, allowing it to receive the NID. The mobile device 40 may then request data related to the node 20 from the data server 50 through the mobile data connection.

In an alternate embodiment, the mobile device 40 may request data related to all nodes 20 within a region near the current location of the mobile device 40 or an anticipated location of the mobile device 40 from the data server 50 through the mobile data connection prior to receiving the NID from the node 20. When the mobile device 40 receives the data from the data server 50, it may store the data in a database contained in the internal memory or external memory of the mobile device 40.

The data may be presented in a file format suitable for compartmentalizing information, such as JavaScript Object Notation (JSON), Standard Generalized Markup Language (SGML), or Extensible Markup Language (XML). Software on the mobile device may then interpret the data as containing headings, subheadings, chapters, subchapters, or other organizational structures characterized by the data received.

Software on the mobile device 40 may then display headings and subheadings on the screen of the mobile device 40. The user may select a particular heading or subheading to display the content of the associated chapter or subchapter on the screen of the mobile device 40. The content of the chapter may include text and other media, such as images, audio, or video. Media may be included in the content either by creating a link to an external resource accessible on the internet or embedding the media in the content.

In the event that the mobile device 40 enters the range of a second signal 32 of a second information node 22, software on the mobile device 40 displays a list of nodes 20, 22 from which the mobile device 40 can currently receive a signal 20, 22. The user may then select a node 20, 22 to view information.

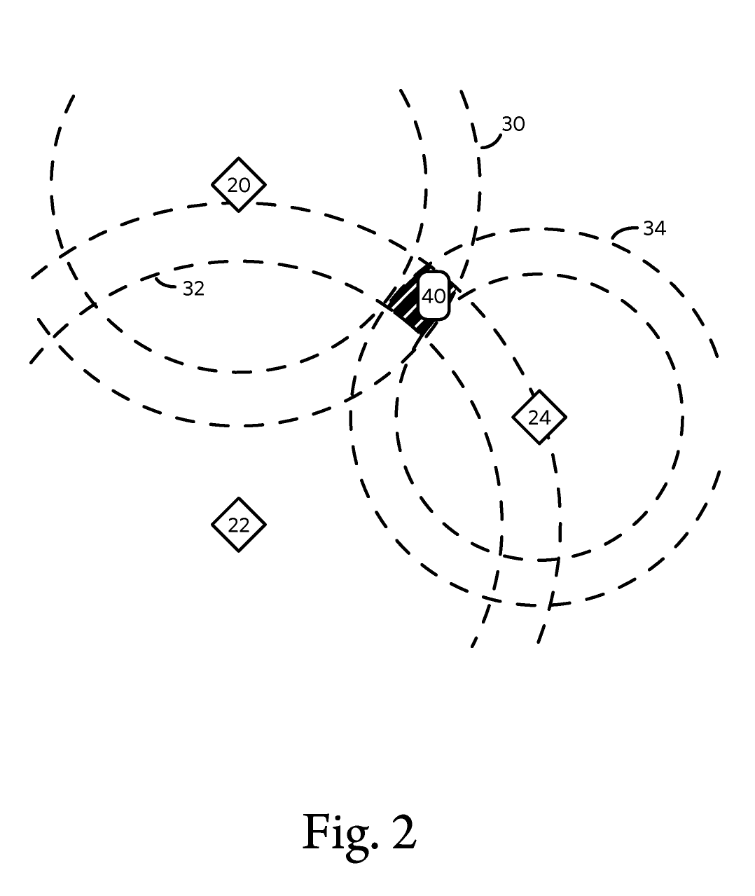

Referring now to FIG. 2, a network of nodes 20, 22, 24 may be used to provide an approximate location of the user. Signal 30, 32, 34 strength of a wireless information node 20, 22, 24 may be used to provide an approximate distance from that node 20, 22, 24. The addition of two or more additional nodes 20, 22, 24 allows software on the mobile device 40 to triangulate the approximate location of the mobile device 40, provided location coordinates of the nodes 20, 22, 24 are known.

Once a user's approximate location is known, the mobile device 40 may utilize map software to determine distance and direction to points of interest associated with data received by the mobile device 40.

Data associated with a node 20 may include information regarding facility amenities, such as seating and restrooms, menus for restaurants, hours of operation for a facility, instruction manuals for items, or other information of interest to a user.

Information displayed on the screen of the mobile device 40 may be read by text-to-speech software on the mobile device 40, should the user wish to receive the information aurally, rather than visually.

Information associated with a node 20 may be updated by accessing the data server 50 and updating data files contained on the data server 50. After updating data on the data server 50, the updated data is delivered to the mobile device 40 upon the next request for node 20 data or refreshing the database stored on the memory of the mobile device 40.

We claim:

1. A method for item and location information distribution comprising the steps of:
(A) providing a mobile device, the mobile device comprising
(i) a user interface,
(ii) a data chip set, and
(iii) a local wireless communication chip set;
(B) providing a data network;
(C) providing a data server;
(D) providing at least one wireless information node;
(E) transmitting a node identification from the wireless information node;
(F) receiving the node identification through the local wireless communication chip set;
(G) transmitting a request from the mobile device to the data server via the data chip set through the data network for data associated with one or more wireless information nodes;
(H) receiving data from the data server with the mobile device, the data comprising
(i) one or more information headings, and
(ii) one or more information chapter texts;
(I) displaying the one or more information headings on the user interface of the mobile device; and
(J) displaying an information chapter text upon selection of an associated information heading.

2. The method of claim 1 wherein the data from the data server further comprises images, audio, video, or links to external media.

3. The method of claim 1 wherein:
(A) at least three wireless information nodes are provided;
(B) the at least three wireless information nodes are placed such that their signals overlap in a geographic area;
(C) a location for each of the at least three wireless information nodes is recorded;
(D) a distance between the mobile device and each of the at least three wireless information nodes is calculated based on signal strength received by the mobile device; and
(E) a location of the mobile device is calculated based on the distance between the mobile device and each of the at least three wireless information nodes.

4. A method for item and location information distribution comprising the steps of:
(A) providing a mobile device, the mobile device comprising
(i) a user interface,
(ii) a data chip set, and
(iii) a local wireless communication chip set;
(B) providing a data network;
(C) providing a data server;
(D) providing at least three wireless information nodes, such nodes being placed such that their signals overlap in a geographic area;
(E) recording a location for the at least three wireless information nodes;
(F) calculating a distance between the mobile device and each of the at least three wireless information nodes based on signal strength received by the mobile device;
(G) calculating a location of the mobile device based on the distance between the mobile device and each of the at least three wireless information nodes;
(H) transmitting a node identification from the wireless information node;
(I) receiving the node identification through the local wireless communication chip set;
(J) transmitting a request from the mobile device to the data server via the data chip set through the data network for data associated with one or more wireless information nodes;
(K) receiving data from the data server with the mobile device, the data comprising
(i) one or more information headings, and
(ii) one or more information chapter texts;
(L) displaying the one or more information headings on the user interface of the mobile device; and
(M) displaying an information chapter text upon selection of an associated information heading.

5. The method of claim 4, wherein the data from the data server further comprises images, audio, video, or links to external media.
